(19) United States
(12) Patent Application Publication
(10) Pub. No.: US 2005/0043092 A1
(43) Pub. Date: Feb. 24, 2005

(54) Gaming machine with selectable features

(75) Inventor: Michael Gauselmann, Espelkamp (DE)

Correspondence Address: PATENT LAW GROUP LLP, 2635 NORTH FIRST STREET, SUITE 223, SAN JOSE, CA, 95134, US

(73) Assignee: Atronic International GmbH

(21) Appl. No.: 10/956,547

(22) Filed: Oct. 1, 2004

Related U.S. Application Data
(63) Continuation of application No. 10/236,572, filed on Sep. 5, 2002.

(51) Int. Cl. A63F 13/00

(52) U.S. Cl. 463/36

(57) ABSTRACT

A programmable electronic gaming machine is disclosed where either a player, a casino operator, or both have the option of selecting the personality of the gaming machine using a display in the gaming machine. One such personality is the pay loading of the game. Other personalities that may be selected by the player and/or the casino operator include the language displayed, the sound volume, the minimum reel spinning time, the display brightness, the arrangement of symbols on each of the reels, the number of paylines, the denominations, the number of reels, award multipliers for special symbols, payout/pay-in percentage, game versions, special symbols, and any other features.

### FIELD OF THE INVENTION

This invention relates to gaming devices, such as slot machines, and in particular to a technique for selecting certain game characteristics to be used in an electronic gaming machine.

### BACKGROUND

The most popular gaming machine is of the type that randomly displays a combination of symbols, where credits or money is awarded to the player based on the resulting combination of symbols. The award amount for a certain symbol combination is based on the probability of that symbol combination occurring. Such a gaming machine may use motor-driven reels or a video screen that simulates motor-driven reels.

Modem gaming machines are controlled by a microprocessor carrying out a software program. The software program includes a pseudo-random number generator that selects the outcome of the game, and the display of the reels is essentially used to generate excitement in the player before displaying the predetermined outcome. The designer of the program achieves a certain payout/pay-in percentage by adjusting the probabilities of the various winning symbol combinations occurring and the payout for each of the symbol combinations. A typical payout/pay-in percentage is 97%.

The same payout/pay-in percentage can be achieved by either: 1) more frequent wins but lower average payouts per win, or 2) less frequent wins but higher average payouts per win. This is referred to as pay loading. A compromise of these two pay loading schemes is made by the designer of the software to achieve the desired payout/pay-in percentage while making the payouts appealing to the average player.

However, some players are most attracted to gaming machines that offer higher average payouts per win but a lower frequency of medium and low payouts, while other players are most attracted to gaming machines that offer lower average payouts per win but more frequent medium and low payouts. Accordingly, the prior art gaming machines do not offer many players their ideal pay loading scheme.

### SUMMARY

A programmable electronic gaming machine is disclosed where either a player, a casino operator, or both have the option of selecting the personality of the gaming machine. One such personality is the pay loading of the game.

In one embodiment, the gaming machine is a video slot machine displaying simulated rotating reels that are randomly stopped to identify a symbol combination. A symbol combination corresponds to an award amount. Prior to the play, the player may be presented with a menu on the display screen so that the player can choose various features of the machine. If the display is a touch screen type of display, the player may simply touch one of the offered options in order to select the personality of the machine.

Some selectable personalities may include pay loading where the player is presented with three payout personality modes: leisure, pleasure, and pressure; The leisure mode selects software that causes the win frequency to be high but the average payout per win to be low. The pleasure mode selects software that causes the win frequency to be medium and the average payout per win to be medium. The pressure mode selects software that causes the win frequency to be low but the average payout per win to be high. Additional modes may be offered.

The configuring of the gaming machine may be performed by the player or a casino operator (an employee of the casino). A casino operator may configure the gaming machine remotely via a network or at the gaming machine itself.

Other features may also be selected by the player and/or the casino operator, such as the language displayed, the sound volume, the minimum reel spinning time, the display brightness, the arrangement of symbols on each of the reels, the number of paylines, the denominations, the number of reels, award multipliers for special symbols, payout/pay-in percentage, game versions, special symbols, and any other features.

In one embodiment, after a machine has been set up by the casino operator, a printer in the gaming machine prints outs out the configuration settings of the machine to summarize the settings for verification.

### BRIEF DESCRIPTION OF THE DRAWINGS

FIG. 1 is a perspective view of one type of gaming machine that may incorporate the present invention.

FIG. 2 is a block diagram of certain functional units within the gaming machine of FIG. 1.

FIG. 3 illustrates a menu screen presented to the player or an operator for selecting a pay loading mode such as leisure, pleasure, or pressure.

FIGS. 4-8 illustrate other displays of personality options for selection by the player or the casino operator.

### DETAILED DESCRIPTION

The invention is primarily software related, and numerous hardware implementations are possible in conjunction with the invention. One particular gaming machine platform and network will be described as an example.

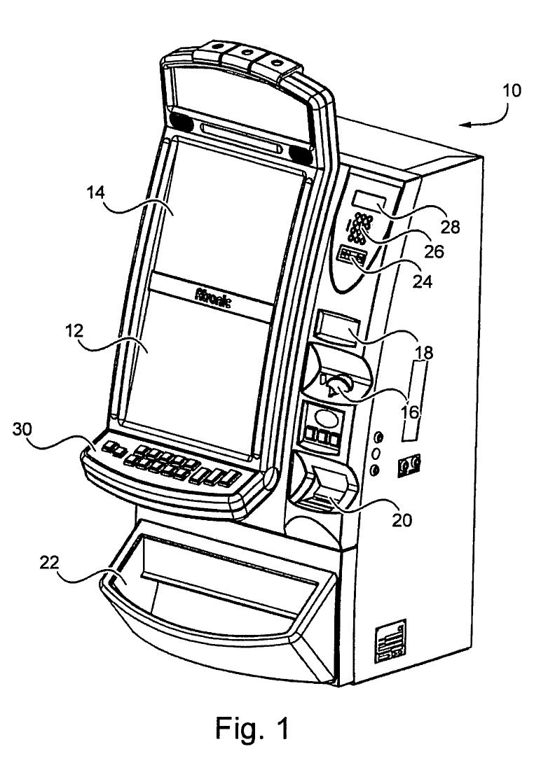

FIG. 1 is a perspective view of a gaming machine 10 that can be used in the present invention. Machine 10 includes a display 12 that may be a thin film transistor (TFT) display, a liquid crystal display (LCD), a cathode ray tube (CRT), or any other type of display. A second display 14 provides game data or other information in addition to display 12. Display 14 may provide static information, such as an advertisement for the game, the rules of the game, pay tables, paylines, or other information, or may even display the game itself along with display 12. Alternatively, the area for display 14 may be a display glass for conveying information about the game.

A coin slot 16 accepts coins or tokens in one or more denominations to generate credits within machine 10 for playing games. An input slot 18 for an optical reader and printer receives machine readable printed tickets and outputs printed tickets for use in cashless gaming. A bill acceptor 20 accepts various denominations of banknotes.

A coin tray 22 receives coins or tokens from a hopper upon a win or upon the player cashing out.

A card reader slot 24 accepts any of various types of cards, such as smart cards, magnetic strip cards, or other types of cards conveying machine readable information. The card reader reads the inserted card for player and credit information for cashless gaming. The card reader may also include an optical reader and printer for reading and printing coded barcodes and other information on a paper ticket.

A keypad 26 accepts player input, such as a personal identification number (PIN) or any other player information. A display 28 above keypad 26 displays a menu for instructions and other information and provides visual feedback of the keys pressed.

Player control buttons 30 include any buttons needed for the play of the particular game or games offered by machine 10 including, for example, a bet button, a repeat bet button, a play two-ways button, a spin reels button, a deal button, hold cards buttons, a draw button, a maximum bet button, a cash-out button, a display paylines button, a display payout tables button, and any other suitable button. Buttons 30 may be replaced by a touch screen, such as display 12, with virtual buttons.

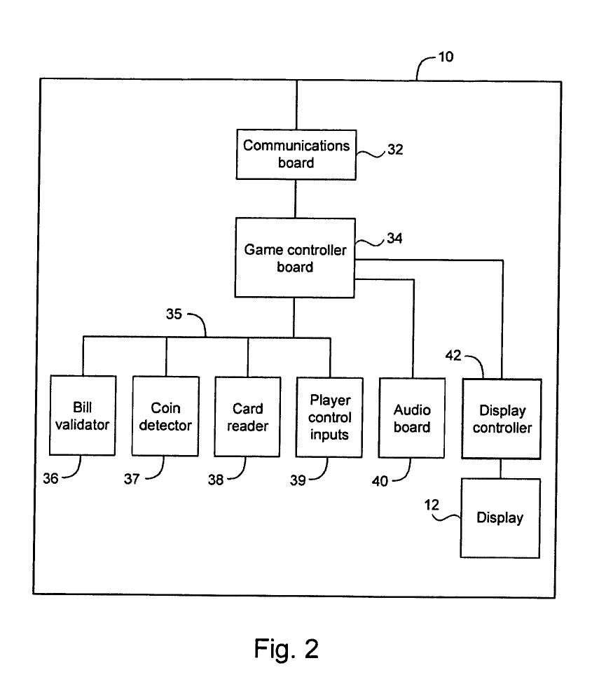

FIG. 2 illustrates basic circuit blocks in a suitable gaming machine 10. The gaming device 10 may use conventional hardware. A communications board 32 may contain conventional circuitry for coupling the gaming machine 10 to a local area network (LAN) or other type of network using Ethernet or any other protocol. The communications board 32 transmits using a wireless transmitter, or it may be directly connected to a network running throughout the casino floor. The communications board 32 basically sets up a communication link with a network server and buffers data between the network and the game controller board 34.

The game controller board 34 contains memory and a processor for carrying out programs stored in the memory and for providing the information requested by the network. The game controller board 34 carries out the game routine and applies various configurable parameters to the game routine, which will be discussed in detail below.

Peripheral devices/boards communicate with the game controller board 34 via a standard bus 35 using, for example, an RS-232 interface. Such peripherals may include a bill validator 36, a coin detector 37, a smart card reader or other type of credit card reader 38, and player control inputs 39 (such as the various buttons 30 shown in FIG. 1 or a touch screen). An audio board 40 converts coded signals into analog signals for driving speakers. A display controller 42, which typically requires a high data transfer rate, converts coded signals to pixel signals for the display 12. Display controller 42 and audio board 40 may be directly connected to parallel ports on the game controller board 34.

The electronics on the various boards may be combined onto a single board.

Once the gaming machine is installed in, for example, a casino, the machine is configurable by a casino operator either at the gaming machine itself or by using a remote terminal connected to the gaming machine via a network. It will be assumed that the machine is configurable by the operator selecting various options from the display 12 in the gaming machine using a touch screen interface. The machine is set to an initialize or configuration mode using a key, a keypad code, a special card, or other means. Various menus are then presented to the operator for the operator to select a particular characteristic or personality of the machine. A subset of all of these characteristics (or additional characteristics) may also be presented to the player prior to the player playing the gaming machine to allow the player to select the machine's personality.

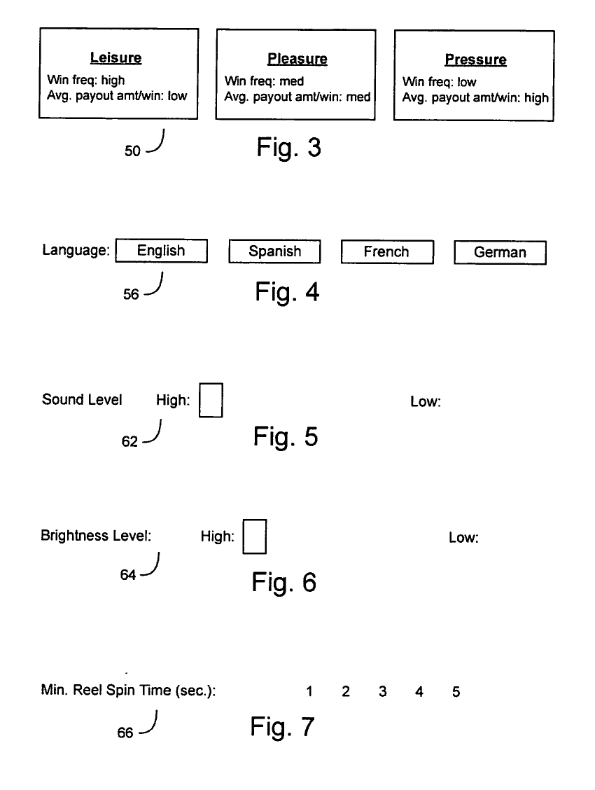

FIG. 3 illustrates a display 50 on a screen to allow either the casino operator or the player select a pay loading mode. Each mode pertains to different software already stored in the memory of the gaming machine, and the selection of a pay loading mode selects the software for use in playing the game. A first mode is termed the “leisure” mode, which provides a high win frequency but a low average payout amount per win (e.g., 2-5 credits). The win frequency and average payout per win are chosen by the software designer to result in the casino's desired payout/pay-in percentage, such as 97%. The player or operator may select this option by touching the icon on the screen associated with the leisure mode.

Another pay loading mode is termed the “pleasure” mode, which provides a medium win frequency and a medium average payout amount per win (e.g., 5-10 credits). This also results in the desired payout/pay-in percentage for the casino, equal to that of the leisure mode.

The third mode is termed the “pressure” mode, which provides a low win frequency but a high average payout amount per win (e.g., greater than 10 credits) to achieve the same payout/pay-in percentage as the other two modes. Of course, many other types of modes may be used. The machine designer or the casino decides if the machine is to offer the player the opportunity to choose the mode of operation or whether the selection is for the casino operator only during an initialization mode for the gaming machine. One example of the use of the leisure mode selected by a casino operator is for gaming machines at an entrance to a casino so that people entering the casino will see many players winning.

In one embodiment, the operator selects a default mode in case the player decides not to configure the machine.

The selection of a mode selects particular software in the program ROM that changes the probabilities of various winning symbol combinations being randomly selected by the random number generator. The setting of outcome probabilities in gaming machines is well known. In one embodiment, each symbol or symbol combination outcome is associated with one or more random numbers in a lookup table. Associating a particular symbol or symbol combination with more random numbers increases the chances that the random number generator will select that symbol or symbol combination as an outcome, while associating a particular symbol or symbol combination with less random numbers decreases the chances that the random number generator will select that symbol or symbol combination as an outcome. Each such lookup table is associated with a pay loading mode.

The player may be prompted to set the personality of the gaming machine by a touch screen icon, by a physical button, or by any other means.

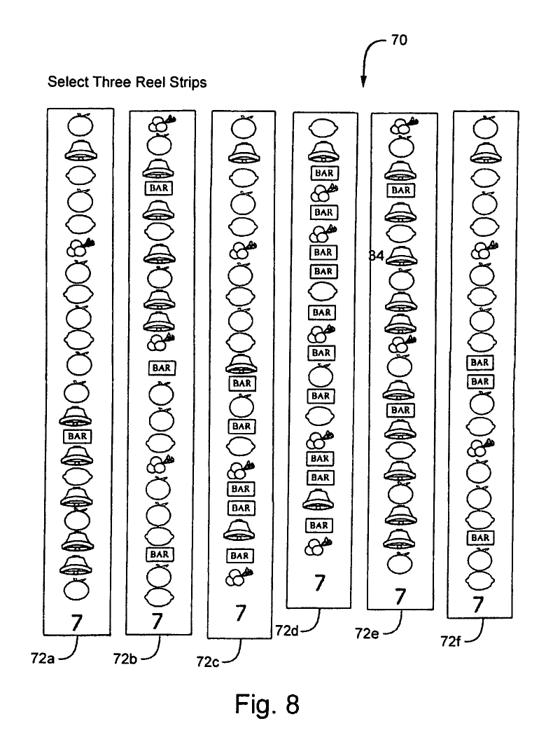

FIGS. 4-8 illustrate other displays that the player or operator may use to select the personality of the machine by touching an area of the screen to make the selection. FIG. 4 illustrates a display 56 for the player or operator to select the language used on the screen and for any audio output of the machine. FIG. 5 illustrates a display 62 for the player or operator to adjust the sound level of the machine. FIG. 6 illustrates a display 64 for the player or operator to control the brightness of the display. FIG. 7 illustrates a display 66 where the player or operator may adjust the minimum reel spinning time (or simulated reel spinning time if a video display is used) before a reel stops to display the predetermined symbol. FIG. 8 illustrates a display 70 for the player or operator to select a reel strip 72a-f for each of the reels. The selection of a reel strip causes a particular software program to be selected to display that strip around a reel in a video slot machine. The player may also create her own reel strips using a set of symbols.

Other personalities may also be set by the player or the casino operator, including the number of paylines across a reel symbol array, the monetary denominations acceptable by the machine, the number of reels, the values of certain special symbols, such as multiplication values associated with such symbols (or whether the symbol is a wild card, etc.), a payout/pay-in percentage, the type or types of games available (including whether the game is to be a free game, a credit game, or bonus game, or a progressive game, etc.), the values or types of symbols to be displayed by the reels, including special symbols, certain special payouts for special symbol combinations, the activation of various features such as a double or nothing feature, or any other personality.

A payline is a straight or jagged line that intersects certain reel symbol positions. The determination of a win is based on the symbol combination(s) across the activated payline(s). In one embodiment, the player is allowed to create her own payline(s), even unconventional ones, or may choose from a set of paylines.

The operator may initially set the various ranges for the personalities to be selected by the player.

If no credits are in the machine, the machine will assume that the player has left the machine and may automatically reset the various personalities to default personalities.

The personality of a bonus game may also be selected on screen by the operator. Such a bonus game is activated by a special outcome of the main game, such as by a special combination of symbols. The bonus game can be any game, displayed on the same display used for the main game or on a different display, in which the player has an opportunity to win a bonus award. One such bonus game offers the player multiple selections, each with a hidden award value, and the player arbitrarily selects the hidden awards until the player selects an end-bonus-game icon or until the player has made a predetermined number of selections. Features in the bonus game or the main game that the operator and/or a player may activate from the screen include: 1) whether the player gets hints during the bonus game of which options to choose; 2) whether the player could increase a bet during the bonus game; 3) the selection of the trigger combination in the main game to trigger the bonus game; 4) a maximum bet by a player during any of the games; 5) the selection of a particular type of bonus game, such as a second screen bonus game, a free game, a reel feature (e.g., a bonus feature involving the video reels), a mystery feature, a double up feature, etc.; 6) the pay loading of the bonus game (e.g., the hit frequency); and 7) the range of awards given, such as the number of free games and special pay rules during free games, or the possible awards during a bonus game.

As seen, there may be many different configurations of a single gaming machine, which adds flexibility and profitability to the machine.

In one embodiment, to verify the selected configuration set by an operator, the gaming machine may include a printer that outputs a paper tape identifying the selected configuration settings of the machine after the machine has been installed. The operator may then have to sign and date the printout to acknowledge the installation. This signed printout may be used to complete the contract between the casino and the gaming machine manufacturer. Additionally, after all the settings are made, the display on the machine may provide a summary of all the configurations, and this summary may be approved by the operator and then printed out and issued to the operator. In another embodiment, the printout of the configuration settings can be via an external printer, where the configuration information is transmitted from the gaming machine via a wired or wireless connection to a central printer or to a handheld printer.

After the configuration has been set by the player or operator, the machine's configuration program checks the configuration to ensure the settings guarantee the proper working of the gaming machine. If not, the player or operator is prompted to select a different configuration.

All settings and all changes may be stored in a memory file for later verification.

In one embodiment, a plurality of gaming machines are connected together in a network, and the configuration settings of one gaming machine are downloaded to other gaming machines in the network so that all the gaming machines have the same initial personality.

While particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

1. A method performed by a gaming machine comprising:
offering to a player of the gaming machine on a display screen an option to select a minimum reel spinning time for simulated reels displayed on the display screen;
receiving a player input, via the display screen, identifying a minimum reel spinning time; and
conducting a game by the gaming machine using the selected minimum reel spinning time.

2. The method of claim 1 wherein offering to a player of the gaming machine on a display screen an option to select a minimum reel spinning time comprising offering to the player spin times including a range of 2-4 seconds.

3. The method of claim 1 wherein offering to a player of the gaming machine on a display screen an option to select a minimum reel spinning time comprising offering to the player spin times including a range of 1-5 seconds.

4. A method performed by a gaming machine, the gaming machine being configured for use by a casino operator, the method comprising:
offering to the operator on a display screen of the gaming machine an option to select a minimum reel spinning time for simulated reels displayed on the display screen;
receiving an operator input, via the display screen, identifying a minimum reel spinning time; and
conducting a game by the gaming machine using the identified minimum reel spinning time.

5. The method of claim 4 wherein offering to the operator on a display screen of the gaming machine an option to select a minimum reel spinning time comprising offering to the operator spin times including a range of 2-4 seconds.

6. The method of claim 4 wherein offering to the operator on a display screen of the gaming machine an option to select a minimum reel spinning time comprising offering to the operator spin times including a range of 1-5 seconds.

7. A method performed by a gaming machine comprising:
offering to a player of the gaming machine on a display screen an option to select a number of simulated reels displayed on the display screen during a game;
receiving a player input identifying a number of simulated reels; and
conducting a game by the gaming machine using the selected number of simulated reels.

8. The method of claim 7 wherein receiving a player input identifying a number of simulated reels comprises receiving a player input via a touch screen identifying a number of simulated reels.

9. A method performed by a gaming machine, the gaming machine being configured for use by a casino operator, the method comprising:
offering to the operator on a display screen of the gaming machine an option to select, via the display screen, a number of simulated reels displayed on the display screen;
receiving an operator input, via the display screen, identifying a number of simulated reels displayed on the display screen; and
conducting a game by the gaming machine using the identified number of simulated reels.

10. A method performed by a gaming machine comprising:
offering to a player of the gaming machine on a display screen an option to select one of a variety of sets of symbol strips for simulated reels displayed on the display screen during a game, the sets of symbol strips differing in arrangements and combinations of symbols;
receiving a player input, via the display screen, identifying a set of symbol strips; and
conducting a game by the gaming machine using the selected set of symbol strips.

11. A method performed by a gaming machine, the gaming machine being configured for use by a casino operator, the method comprising:
offering to the operator on a display screen of the gaming machine a selection of different sets of symbol strips for simulated reels displayed on the display screen, the sets of symbol strips differing in arrangements and combinations of symbols;
receiving an operator input, via the display screen, identifying a selected set of symbol strips; and
conducting a game by the gaming machine using the selected set of symbol strips.

12. The method of claim 11 further comprising printing out a record of a selected configuration of the gaming machine.

13. The method claim 12 wherein printing out a record comprises printing out a record via a printer in the gaming machine.

14. The method claim 12 wherein printing out a record comprises printing out a record via a printer external to the gaming machine.
